(19) United States
(12) Patent Application Publication
(10) Pub. No.: US 2011/0177789 A1
(43) Pub. Date: Jul. 21, 2011

(54) LOW NOISE AMPLIFIER AND THE USES THEREOF

(76) Inventors: Wang Chi Cheng, Hong Kong (HK); Jun Zhou, Hong Kong (HK)

(21) Appl. No.: 12/690,482

(22) Filed: Jan. 20, 2010

(51) Int. Cl. H04B 1/40; H04B 7/00

(52) U.S. Cl. 455/73; 455/234.1

(57) ABSTRACT

A low noise amplifier (110) is disclosed that is particularly suitable for ultra wideband telecommunications. The low noise amplifier (110) provides a variable gain by a current controller (115) to amplify signals received directly from an antenna (140) and sends the amplified signal to a receiver (111). In a transceiver configuration, the low noise amplifier (110) is further connected to a transmitter (133) through a switch (120) which provides zero power consumption which the switch (120) is turned on and provides high impedance when the switch (120) is turned off.

### TECHNICAL FIELD

The present invention relates to a circuit. More particularly, the present invention relates to a circuit implementation of a low noise amplifier (LNA). The low noise amplifier is particularly applicable to perform low noise amplification of ultra wideband (UWB) signal.

### BACKGROUND

A low noise amplifier is used to amplify a signal. In general, a low noise amplifier is used to amplify very weak signals captured by an antenna. It is always desirable to have a low noise amplifier which is capable of providing variable gain. For example, a larger gain is required if the signal from the antenna is too weak while a lower gain is enough if the signal from an antenna is too strong. If the gain is not fixed to one or two specific values but has a range of possible values, a higher flexibility is provided. Furthermore, it is desirable to have a low noise amplifier which receive signals from an antenna without introducing any noise or with any noise introduced minimized.

There is a need in the art for a low noise amplifier with variable gain, and for a low noise amplifier for use in a transceiver.

### SUMMARY

Disclosed herein is a low noise amplifier that can vary gain by using a transistor. The use of one transistor saves the silicon area and provides an efficient way to control the gain for the output of the low noise amplifier. The design of a low noise amplifier with a transistor as a current controller enables simple architecture and implementation. Instead of limiting the gain to one or two specific values, the present invention provides the gain with a plurality of values. The transistor is preferably a CMOS (Complementary Metal Oxide Silicon), as CMOS provides the low noise amplifier with higher noise immunity and lower power consumption.

To eliminate any possible noise introduction to the low noise amplifier, the low noise amplifier is directly connected to the antenna to receive signals from the antenna directly. No external inductor or resonant tank (LC circuit) is connected between the antenna and the low noise amplifier in order to minimize the insertion loss. Furthermore, load matching is performed between the antenna and the low noise amplifier to reduce the mismatch loss for the low noise amplifier.

The low noise amplifier is also applicable to a transceiver by installing the low noise amplifier along a receiver path to provide the gain as required by the receiver. Furthermore, a switch is provided along a transmitter path to cut the transmitter off from the rest of the transceiver circuit when the transceiver functions as a receiver. The complete isolation of the transmitter path by the switch to eliminate any noise contributed from the transmitter path.

When the transceiver functions as a receiver, the switch completes the transmitter path and the high impedance of the low noise amplifier ensures that the signal from the transmitter is sent to the antenna without being degraded by the receiver path. If the switch leads to any power loss for a signal from the transmitter, a power amplifier is provided between the transmitter and the switch to compensate for any power loss.

### BRIEF DESCRIPTION OF THE DRAWINGS

These and other objects, aspects and embodiments of this present invention will be described hereinafter in more details with reference to the following drawings, in which:

FIG. 1 shows a block diagram illustrating a low noise amplifier.

FIG. 2 shows a schematic diagram of a low noise amplifier.

FIG. 3 shows a schematic diagram of a transceiver.

### DETAILED DESCRIPTION

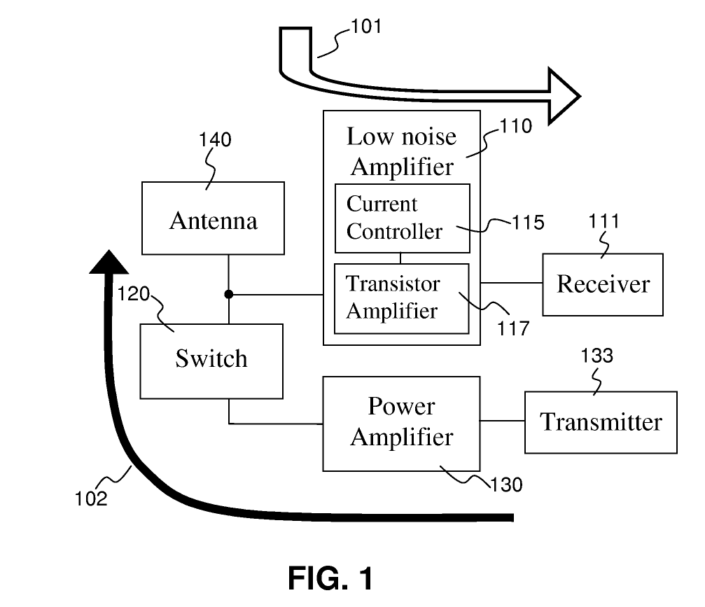

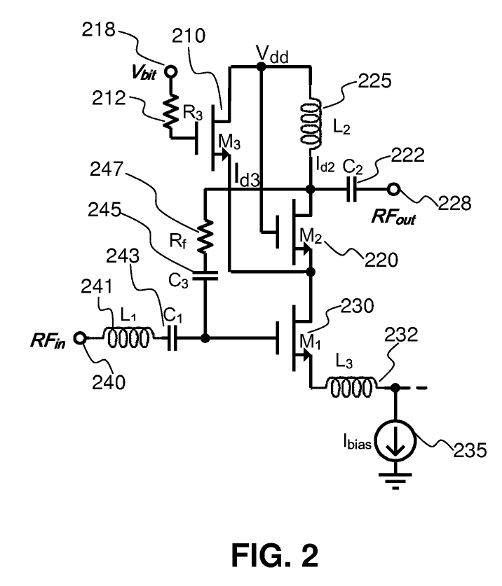

FIG. 1 shows a block diagram illustrating a low noise amplifier. A low noise amplifier 110 includes a transistor amplifier 117 which generate a variable gain. The low noise amplifier further includes a current controller 115 which varies the gain generated by the transistor amplifier 117. By controlling the current flowing through the transistor amplifier 117, the current controller 115 allows the transistor amplifier 117 to generate an output signal with a variable gain and the variable gain has a plurality of magnitudes rather than simply a fixed magnitude or two stages of magnitudes. The transistor amplifier 117 is directly connected to an antenna 140 and receives a signal from the antenna 140. The signal received from the antenna 140 has an ultra wide bandwidth. A receiver path 101 is formed with the flow of signal from the antenna 140 to the low noise amplifier 110 and from the low noise amplifier 110 to a receiver 111. Since the current controller 115 and the transistor amplifier shares the same voltage source, the larger the current flowing through the current controller 115, the lower the current that flows through the transistor amplifier 117. The lower the current, I_{d3}, flowing through the current controller 115, the larger the current, I_{d2}, that flows through the transistor amplifier 117, whereas the bias current source 235, I_{bias}, flowing through an inductor L₃ 232 is constant as shown in FIG. 2.

I_{bias}=I_{d3}+I_{d2} (1)

As a result, the variable gain Aᵥ provided by the transistor amplifier 117 is proportional to the current flowing through the transistor amplifier 117, I_{d, transistor amplifier 117}.

Aᵥ=I_{d, transistor amplifier 117}×Z_{L2, 225} (2)

In addition, the low noise amplifier 110 is used in a transceiver. In a transceiver, the receiver 111 shares the antenna 140 with a transmitter 133. The low noise amplifier 110 uses the antenna 140 to receive a signal and amplifies the received signal before sending the received signal to the receiver 111. The transmitter 133 uses the antenna 140 to transmit a signal. The low noise amplifier 110 further includes a switch 120 which switches off the low noise amplifier 110 when the transceiver transmits a signal and switches on the low noise amplifier 110 when the transceiver receives a signal.

When the low noise amplifier 110 is switched off by the switch 120, the low noise amplifier 110 has high impedance. Because of the high impedance, no signal will leak through the low noise amplifier 110 so that it is not required to have a switch to cut off the path between the low noise amplifier 110 and the antenna 140. Furthermore, the transmitter 133 is connected to the antenna 140 through the switch 120 and the switch 120 allows the signal to flow through the switch 120 with a minimum power loss. In one embodiment, a power amplifier 130 is used to amplify the output of the transmitter 133 to compensate for any power loss contributed by the switch 120. A transmitter path 102 is formed by the flow of a signal from the transmitter 133 to the power amplifier 130, from the power amplifier 130 to the switch 120, and further from the switch 120 to the antenna 140.

When the low noise amplifier 110 is switched on by switch 120, switch 120 cuts off the path between transmitter 133 and antenna 140. The direct connection between the low noise amplifier 110 and the antenna 140 eliminates any power loss or noise contributed by the path between the low noise amplifier 110 and the antenna 140. The signal from the antenna will follow along the receiver path 101 and be amplified with a variable gain provided by the low noise amplifier 110.

FIG. 2 shows a schematic diagram of a low noise amplifier. The low noise amplifier includes a current controller which is transistor M₃ 210. By varying the gate voltage V_{bit} 218 of the transistor M₃ 210, transistor M₃ 210 controls the current I_{d3} which flows through the transistor M₃ 210 and thus controls the current I_{d2} which flows through the transistor M₂ 220. In one embodiment, a resistor R₃ 212 is provided between the gate terminal of the transistor M₃ 210 and the gate voltage V_{bit} 218 and the gate voltage V_{bit} 218 is varied by varying the resistance provided by the resistor R₃ 212. A function of R₃ 212 is to provide better isolation between the V_{bit} 218 voltage and high frequency signal leakage caused by M₃ 210. In one embodiment, the gate voltage V_{bit} 218 is varied according to a digital control bit.

Both transistors M₃ 210 and M₂ 220 have their drain terminals connected to the same voltage source V_{dd} so that the current I_{d3} and the current I_{d2} share the same source. When the gate voltage V_{bit} 218 is decreased by the transistor M₃ 210 is partially on and the current I_{d3} is low so that a larger current I_{d2} will flow through the transistor M₂ 220. When the gate voltage V_{bit} 218 is increased by the transistor M₃ 210 is more fully on and the current I_{d3} is high so that a smaller current I_{d2} will flow through the transistor M₂ 220. By varying the current I_{d2}, the low noise amplifier provides a variable gain to the signal output RFₒᵤₜ 228 of the low noise amplifier.

In addition to being connected to the voltage source V_{dd}, the drain terminal of the transistor M₂ 220 is further connected to a signal input RFᵢₙ 240 of the low noise amplifier. The signal input RFᵢₙ 240, in one embodiment, is a signal received from an antenna. In one embodiment, an inductor L₂ 225 is provided between the voltage source V_{dd} and the drain terminal of the transistor M₂ 220. In yet another embodiment, an inductor L₁ 241, a capacitor C₁ 243, a capacitor C₃ 245 and a resistor R_{f} 247 are connected in series between the drain terminal of the transistor M₂ 220 and the signal input RFᵢₙ 240.

The drain terminal of the transistor M₂ 220 is further connected to the signal output RFₒᵤₜ 228 of the low noise amplifier. The signal output RFₒᵤₜ 228, in one embodiment, is provided to a receiver. In one embodiment, a capacitor C₂ 222 is provided between the signal output RFₒᵤₜ 228 and the drain terminal of the transistor M₂ 220.

The gate terminal of the transistor M₂ 220 is connected to the voltage source V_{dd} and turns the transistor always on as long as the voltage source V_{dd} is available.

The source terminal of the transistor M₂ 220 is connected to the source terminal the transistor M₃ 210 and both the source terminals are connected to the drain terminal of the transistor M₁ 230. By having the transistor M₂ 220 and the transistor M₁ 230 connected in series with the source terminal of the transistor M₂ 220 connected to the drain terminal of the transistor M₁ 230, the transistor M₂ 220 is staggered with the transistor M₁ 230. The transistor M₁ 230 is provided with a bias current I_{bias} by having the source terminal of the transistor M₁ 230 connected to a bias current source 235 through an inductor L₃ 232. The gate terminal of the transistor M₁ 230 is connected to the signal input RFᵢₙ 240. In one embodiment, in addition to being connected to a path to the signal output RFₒᵤₜ 228 through the capacitor C₃ 245 and the resistor R_{f} 247, the inductor L₁ 241 and the capacitor C₁ 243 are connected in series in a path between the gate terminal of the transistor M₁ 230 and the signal input RFᵢₙ 240.

In one embodiment, the transistors M₁ 230, M₂ 220, M₃ 210 are CMOS transistors.

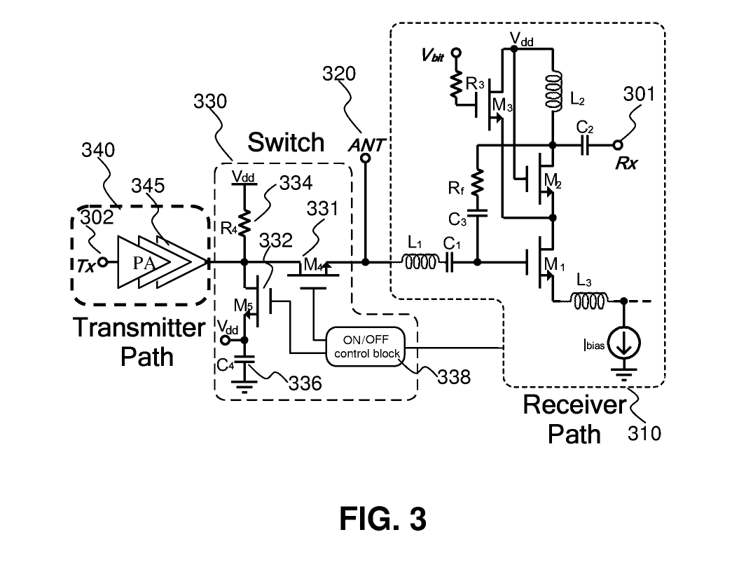

FIG. 3 shows a schematic diagram of a transceiver. The receiver path 310 of the transceiver contains the low noise amplifier as illustrated in FIG. 2. The signal input RFᵢₙ of the low noise amplifier is obtained from an antenna 320. The antenna 320 is directly connected to the low noise amplifier. The signal output RFₒᵤₜ of the low noise amplifier is sent to a receiver 301. To switch between the receiver 301 and a transmitter 302 in a transceiver, a switch 330 is provided between a transmitter path 340 and the antenna 320. In one embodiment, a 50Ω input impedance matching for ultra wideband signals is performed for the low noise amplifier.

The switch 330 includes a control block 338 which is capable of switching on the low noise amplifier as well as switching off the low noise amplifier. The switch 330 includes two transistors M₄ 331 and M₅ 332. When the control block 338 switches off the low noise amplifier by powering off the voltage source V_{dd}, the control block 338 switches on the transmitter path by switching on the transistor M₄ 331 and switching off the transistor M₅ 332. The transistor M₄ 331 is connected to the output of the transmitter path 340. The transmitter path 340 includes a power amplifier 345 which amplifies the signal from the transmitter 302. The voltage source V_{dd} is provided respectively to the drain terminal of the transistor M₅ 332 and the collector terminal of the transistor M₅ 332. It is possible to further add a resistor R₄ between the drain terminal of the transistor M₅ 332 and the voltage source V_{dd}. The drain terminal of the transistor M₅ 332 is further connected to the path between the transmitter path 340 and the transistor M₄ 331. A capacitor 336 is provided to earth the voltage source V_{dd} which is supplied at the source terminal of the transistor M₅ 332.

When the control block 338 switches on the low noise amplifier by powering on the voltage source V_{dd}, the control block 338 switches on the receiver path by switching off the transistor M₄ 331 and switching on the transistor M₅ 332. The signal from the transmitter path 340 is no longer able to reach the antenna 320 as the switch 330 has cut off the path between the transistor 302 and the antenna 320 when the transistors M₄ 331 is shut down and M₅ 332 is power on by shutting off the gate voltage of transistor M₄ 331 and power on the gate voltage of transistor M₅ 332 respectively.

### INDUSTRIAL APPLICABILITY

The low noise amplifier disclosed herein finds particular use in wireless communications, especially ultra wideband applications. The amplifier achieves ultra wideband matching and provides variable gain, making an output with multiple gain stages possible. The low noise amplifier can be implemented in a single chip design solution. In addition, a transceiver for ultra wideband applications may use the low noise amplifier.

The foregoing description is to be considered as illustrative and not restrictive, and the invention is not to be limited to the details given herein, but may be modified within the scope of the appended claims.

We claim:

1. A low noise amplifier for amplifying a signal received from an antenna, the low noise amplifier comprising:
a transistor amplifier connected to the antenna configured to generate an output signal with a variable gain proportional to a current flowing through the transistor amplifier; and
a current controller connected to the transistor amplifier configured to control the current flowing through the transistor amplifier.

2. The low noise amplifier according to claim 1, wherein the magnitude of the variable gain has a plurality of values.

3. The low noise amplifier according to claim 1, wherein the signal received from the antenna has an ultra wide bandwidth.

4. The low noise amplifier according to claim 1, wherein the current controller is a CMOS transistor.

5. The low noise amplifier according to claim 4, wherein the transistor amplifier is a CMOS transistor.

6. The low noise amplifier according to claim 5, wherein the current controller shares the same voltage source with the transistor amplifier.

7. A transceiver for transmitting a signal through an antenna and receiving a signal from the antenna, the transceiver comprising:
a low noise amplifier; and
a switch configured to control the low noise amplifier on and off.

8. The transceiver according to claim 7, wherein the magnitude of the variable gain has a plurality of values.

9. The transceiver according to claim 7, wherein the signal received from the antenna has an ultra wideband bandwidth.

10. The transceiver according to claim 7, wherein the low noise amplifier further comprises:
a transistor amplifier connected to the antenna is configured to generate an output signal with the variable gain proportional to a current flowing through the transistor amplifier.

11. The transceiver according to claim 10, wherein the low noise amplifier further comprises:
a current controller connected to the transistor amplifier is configured to control the current flowing through the transistor amplifier.

12. The transceiver according to claim 11, wherein the current controller is a CMOS transistor.

13. The transceiver according to claim 12, wherein the transistor amplifier is a CMOS transistor.

14. The transceiver according to claim 13, wherein the current controller shares the same voltage source with the transistor amplifier.

15. The transceiver according to claim 7, further comprising:
a power amplifier connected to the transmitter is configured to compensate for power consumption by the switch on the signal received from the transmitter.
